(19) United States
(12) Patent Application Publication
(10) Pub. No.: US 2002/0031416 A1
(43) Pub. Date: Mar. 14, 2002

(54) Wheel nut indicator assembly for vehicle wheels

(76) Inventors: Louis J. Illes, Oakville (CA); Janusz E. Kesik, Burlington (CA)

Correspondence Address: GOWLING LAFLEUR HENDRSON LLP, 120 King Street West, Suite 560, P.O. Box 1045 LCD1, Hamilton, ON, L8N 3R4, CA

(21) Appl. No.: 09/920,968

(22) Filed: Aug. 3, 2001

Related U.S. Application Data
(60) Provisional application No. 60/222,737, filed on Aug. 3, 2000.

(51) Int. Cl. F16B 39/04

(52) U.S. Cl. 411/87

(57) ABSTRACT

A vehicle wheel nut indicator assembly includes a series of wheel nut indicators, each indicator having an annular body which can be fitted over a wheel nut so as to be incapable of rotating relative thereto. Each indicator also has a pair of connector arms extending in opposed directions from the annular body, and a series of connectors each operable to connect a connector arm of one indicator to a connector arm of an adjacent indicator. Indicators can be fitted over each retaining nut of a vehicle wheel and be connected by connectors. Each connector has a frangible portion which will break to disconnect associated connector arms if rotational force is applied thereto by an indicator moving angularly with a loosening nut and thereby provide a visual indication of the loosening of the nut.

This invention claims priority from U.S. Provisional Patent Application No. 60/222737 filed Aug. 3, 2000.

### FIELD OF INVENTION

This invention relates to wheel nut indicators for vehicle wheels, especially wheels on trucks or tractor-railer combinations.

### BACKGROUND OF INVENTION

It is well known that, from time to time, one or more nuts retaining a vehicle wheel in place on an axle may become loose, with the result that the wheel may begin to wobble or even become detached from the vehicle with possibly disastrous consequences. Various proposals have been made to minimize the likelihood of a wheel becoming inadvertently detached from a vehicle axle, but none have proved to be particularly successful in practice.

It is therefore an object of the invention to provide an improved indicator which will give a visual indication of one or more loose vehicle wheel retaining nuts.

### SUMMARY OF INVENTION

According to the invention, a vehicle wheel nut indicator assembly includes a series of wheel nut indicators, each indicator having an annular body which can be fitted over a wheel nut so as to be incapable of rotating relative thereto, each indicator also having a pair of connector arms extending in opposed directions from the annular body, and a series of connectors each operable to connect a connector arm of one indicator to a connector arm of an adjacent indicator, whereby indicators can be fitted over each retaining nut of a vehicle wheel and be connected by connectors, each connector having a frangible portion which will break to disconnect associated connector arms if rotational force is applied thereto by an indicator moving angularly with a loosening nut and thereby provide a visual indication of the loosening of the nut.

### BRIEF DESCRIPTION OF THE DRAWINGS

One embodiment of the invention will now be described, by way of example, with reference to the accompanying drawings, of which:

FIG. 1 is a perspective view of a tractor-trailer combination with wheel nut indicator assemblies in accordance with the invention fitted to each exterior wheel,

FIG. 2 is a diagrammatic view on an enlarged scale of the wheel nut indicator assembly fitted on one of the wheels,

FIG. 3 is a front view of an indicator fitted on a wheel nut,

FIG. 4 is a perspective view of two indicators fitted on two nuts and connected by a connector,

FIG. 5 is a sectional view along the line 5-5 of FIG. 4,

FIG. 6 is a front perspective view of a connector,

FIG. 7 is a rear perspective view thereof, and

FIG. 8 is a diagrammatic view corresponding to a portion of FIG. 2 but showing a loosened wheel nut and missing connector.

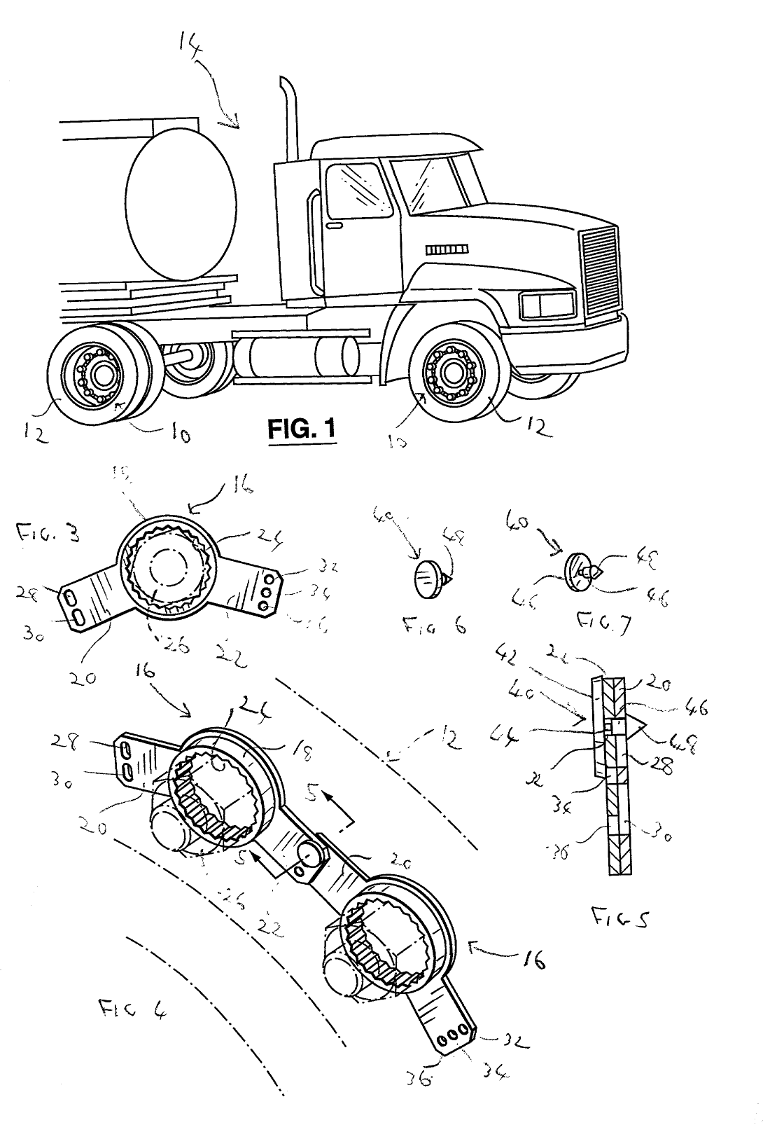

### DESCRIPTION OF PREFERRED EMBODIMENT

Referring to the drawings, a wheel nut indicator assembly 10 for vehicle wheels is fitted over each external wheel 12 of a tractor-trailer combination 14. Each indicator assembly 10 includes a series of indicators 16 of suitable synthetic plastic material. Each indicator 16 has an annular body 18 and pair of connector arms, 20, 22 extending in opposed directions from the indicator body 18. The connector arm 20 has two transversely aligned slots 28, 30 adjacent its free end, and the connector in 22 has three transversely aligned apertures 32, 34, 36 adjacent its free end. The inner surface 24 of the angular body 18 is serrated so that it will fit over wheel nut 26 so as to be incapable of rotating relative thereto.

Each indicator assembly 10 also includes a series of connectors 40, also of suitable synthetic plastic material. Each connector 40 has a flat circular head 42 and a shank extending therefrom with a small diameter frangible portion 44 adjacent to the head 42, a medial portion 46 and a conically shaped pointed end portion 48.

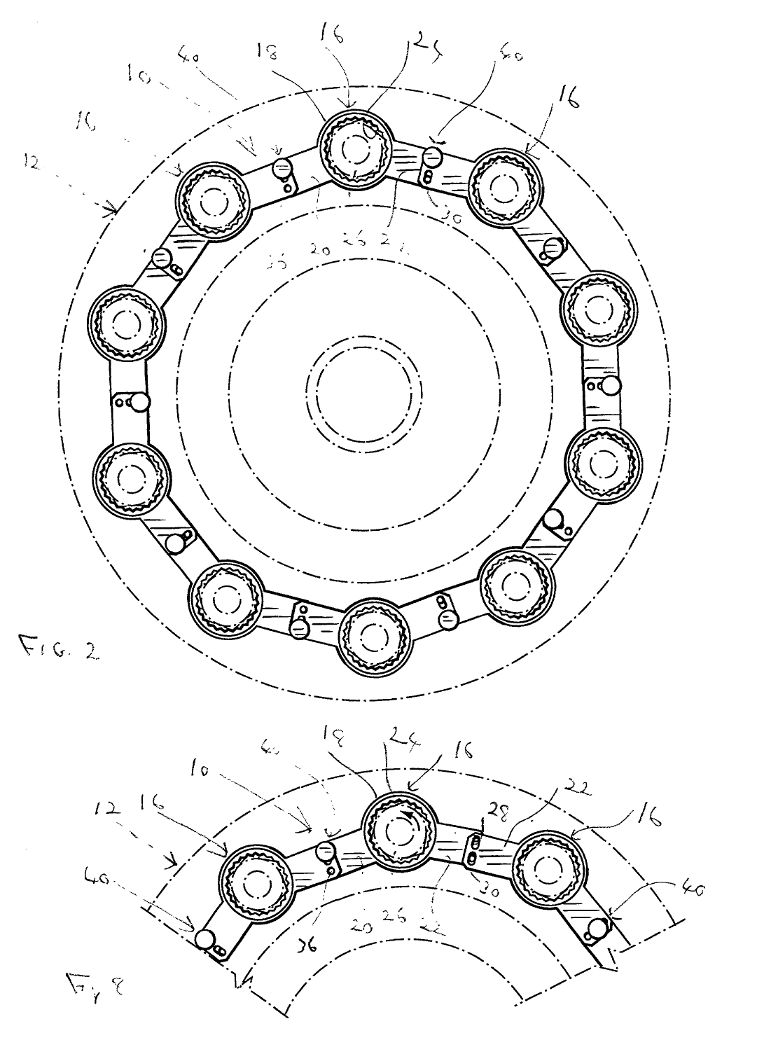

To install an indicator assembly 10 on a wheel 12, an indicator 16 is fitted over each tightened wheel nut 22, and its connector arms 20, 22 are connected to adjacent connector arms 22, 20 by connectors 40. The shank of each connector 40 is passed through one of the apertures 32, 34, 36 of a connector arm 22 and one of the slots 28, 30 in a connector arm 20. As shown in FIG. 5, the conically shaped pointed end portion 48 snaps through the aperture 32 and slot 28 to retain the connector 40 in position. The actual aperture and slot used will depend on the position of adjacent connector arms 20, 22 relative to each other after the indicators 16 have been fitted over the wheel nuts 26.

When all the nuts 26 remain tightened, the indicator assembly is as in FIG. 4. However, if a nut 26 loosens by anti-clockwise rotation as indicated by the arrow on the central nut 26 in FIG. 8, the resultant stress on an adjacent connector 40 will cause the frangible shank portion 44 to break, with the result that the connector 40 becomes detached from the connector arms 20, 22 and falls to the ground. A visual inspection of the wheel will easily reveal that one or more of the indicators 40 is missing, as shown in FIG. 8. Also, the respective connector arms 22, 20 may have become somewhat misaligned as a result of loss of the connector 40, with a result that visual perception of the problem is improved.

It will be readily apparent to a person skilled in the art from the foregoing description of a preferred embodiment that the present invention enables a loosened wheel nut to be visibly detected well before there is imminent danger of a wheel becoming inadvertently detached from the vehicle. Other embodiments of the invention will also now be readily apparent to a person skilled in the art, the scope of the invention being defined in the appended claims.

1. A vehicle wheel nut indicator assembly including a series of wheel nut indicators, each indicator having an annular body which can be fitted over a wheel nut so as to be incapable of rotating relative thereto, each indicator also having a pair of connector arms extending in opposed directions from the annular body, and a series of connectors each operable to connect a connector arm of one indicator to a connector arm of an adjacent indicator, whereby indicators can be fitted over each retaining nut of a vehicle wheel and be connected by connectors, each connector having a frangible portion which will break to disconnect associated connector arms if rotational force is applied thereto by an indicator moving angularly with a loosening nut and thereby provide a visual indication of the loosening of the nut.

2. An indicator assembly according to claim 1 wherein each connector comprises a head and a shank extending therefrom, the shank extending through apertures in adjacent connector arms and having a frangible portion adjacent the head.

3. A vehicle with road-engaging wheels secured thereto by wheel nuts, at least one of the wheels being fitted with a wheel nut indicator assembly including a series of wheel nut indicators, each indicator having an annular body fitted over a wheel nut so as to be incapable of rotating relative thereto, each indicator also having a pair of connector arms extending in opposed directions from the annular body, and a series of connectors each connecting a connector arm at one indicator to a connector arm of an adjacent indicator, whereby indicators are fitted over each nut and are connected by a connector, each connector having a frangible portion which will break to disconnect associated connector arms if rotational forces apply thereto by an indicator moving angularly with a loosening nut and thereby providing a visual indication of the loosening of the nut.

4. A vehicle according to claim 3 wherein each connector of the nut indicator assembly comprises a head and a shank extending therefrom, the shank extending through apertures in adjacent connector arms and having a frangible portion adjacent the head.
